(19) United States
(12) Patent Application Publication
(10) Pub. No.: US 2026/0368066 A1
(43) Pub. Date: Nov. 19, 2026

(54) ALTERNATIVE NOTEBOOK FORMAT FOR AI PROCESSING OF A COMPUTATIONAL NOTEBOOK

(71) Applicant: Microsoft Technology Licensing, LLC, Redmond, WA (US)

(72) Inventors: Peng LYU, Sammamish, WA (US); Don Thilaka Sri JAYAMANNE, Warranwood (AU); Kai-Uwe MAETZEL, Seattle, WA (US)

(21) Appl. No.: 19/208,109

(22) Filed: May 14, 2025

(51) Int. Cl. G06F 11/3604

(52) U.S. Cl. CPC G06F 11/3604

(57) ABSTRACT

Techniques are described herein that are capable of causing an AI model to recommend a change to a computational notebook using an alternative notebook format. A deserialized notebook file, which results from deserialization of a notebook file that defines a computational notebook, is received. The computational notebook includes cells that include subroutines and corresponding outputs. The deserialized notebook file is serialized to provide a serialized notebook file. The serialization includes removing the outputs, adding hash values that uniquely identify the cells, and adding representations of valid programming code snippets representing the subroutines in the deserialized notebook file. An AI model is caused to recommend a change to the notebook file by providing the serialized notebook file to the AI model. An AI output, which includes a recommendation of the change, is received from the AI model. A visual representation of the recommendation is provided via a user interface.

### BACKGROUND

A computational notebook is an interactive document that includes code and text. The text often includes metadata and results that are obtained from executing the code. The computational notebook may further include visualizations, such as charts and graphs of the results from executing the code. Code developers often use computational notebooks for a variety of purposes, such as data analysis, machine learning, and scientific computing. A developer of a computational notebook may wish to interact with an artificial intelligence (AI) model to perform an operation with regard to the computational notebook. However, the traditional format of computational notebooks typically hinders an AI model from efficiently processing the computational notebooks. For instance, computational notebooks having the traditional format often include information that complicates analysis by the AI model, for example, due to the information being susceptible to an unintended interpretation or being tangentially relevant or irrelevant to the analysis.

### SUMMARY

It may be desirable to use an AI model to determine a recommended change to a computational notebook. By serializing a deserialized representation of the computational notebook, the resulting serialized representation of the computational notebook may be provided as an input to the AI model for the purpose of determining the recommended change. A deserialized representation of a computational notebook is a representation of the computational notebook that results from deserializing another representation of the computational notebook. Deserialization is a process of converting serialized data into a data structure (e.g., an object) from which the serialized data was generated. Serialized data is data that is serialized. Serialization is a process of converting a data structure into a format that is capable of being stored or transmitted and later reconstructed. A serialized representation of a computational notebook is a representation of the computational notebook that results from serializing another representation of the computational notebook.

In an aspect, serializing the deserialized representation of the computational notebook in accordance with any one or more of the techniques described herein causes the resulting serialized representation of the computational notebook to have a format that increases efficiency with which the AI model determines the recommended change. For instance, serializing the deserialized representation of the computational notebook may include removing outputs of subroutines, which are included in cells of the computational notebook, from the resulting serialized representation of the computational notebook; replacing identifiers of the cells with hash values; configuring the cells to include language indicators indicating programming language(s) in which the respective subroutines are written; configuring the cells to include representations of valid programming code snippets (e.g., the valid programming code snippets themselves); excluding metadata associated with the computational notebook from the resulting serialized representation of the computational notebook, and so on.

Various approaches are described herein for, among other things, causing an AI model to recommend a change to a computational notebook using an alternative notebook format. In an example approach, a deserialized notebook file is received. The deserialized notebook file results from deserialization of a notebook file that defines a computational notebook in a data serialization format. The computational notebook includes multiple cells that include respective subroutines and outputs of the respective subroutines. The deserialized notebook file is serialized to provide a serialized notebook file. The serializing includes removing the outputs of the respective subroutines from the deserialized notebook file. The serializing further includes adding hash values, which uniquely identify the cells, in the deserialized notebook file. The serializing further includes adding representations of valid programming code snippets, which represent the respective subroutines, in the deserialized notebook file. An AI model is caused to recommend a change to the notebook file by providing an AI input together with contextual information to the AI model. The AI input requests a recommendation of the change. The contextual information includes the serialized notebook file. The contextual information includes context regarding the AI input. An AI output is received from the AI model. The AI output includes the recommendation of the change. A visual representation of the recommendation of the change is provided via a user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example AI-based computational notebook reformatting system in accordance with an embodiment.

FIGS. 2-3 depict flowcharts of example methods for causing an AI model to recommend a change to a computational notebook using an alternative notebook format in accordance with embodiments.

FIG. 4 is a block diagram of an example computing system in accordance with an embodiment.

FIG. 5 is a system diagram of an example mobile device in accordance with an embodiment.

FIG. 6 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to use an AI model to determine a recommended change to a computational notebook. By serializing a deserialized representation of the computational notebook, the resulting serialized representation of the computational notebook may be provided as an input to the AI model for the purpose of determining the recommended change. A deserialized representation of a computational notebook is a representation of the computational notebook that results from deserializing another representation of the computational notebook. Deserialization is a process of converting serialized data into a data structure (e.g., an object) from which the serialized data was generated. Serialized data is data that is serialized. Serialization is a process of converting a data structure into a format that is capable of being stored or transmitted and later reconstructed. A serialized representation of a computational notebook is a representation of the computational notebook that results from serializing another representation of the computational notebook.

In an aspect, serializing the deserialized representation of the computational notebook in accordance with any one or more of the techniques described herein causes the resulting serialized representation of the computational notebook to have a format that increases efficiency with which the AI model determines the recommended change. For instance, serializing the deserialized representation of the computational notebook may include removing outputs of subroutines, which are included in cells of the computational notebook, from the resulting serialized representation of the computational notebook; replacing identifiers of the cells with hash values; configuring the cells to include language indicators indicating programming language(s) in which the respective subroutines are written; configuring the cells to include representations of valid programming code snippets (e.g., the valid programming code snippets themselves); excluding metadata associated with the computational notebook from the resulting serialized representation of the computational notebook, and so on.

An AI model is a model that utilizes artificial intelligence to perform a task in response to an AI input that is received by the AI model. Artificial intelligence is intelligence of a machine (e.g., a computing system) and/or code (e.g., software and/or firmware), as opposed to intelligence of a living creature (e.g., a human). In an aspect, the AI model is an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal. In another aspect, the AI model is a machine learning model. A machine learning model is an AI model that is configured to learn (e.g., acquire intelligence) from data and to make determinations (e.g., predictions) based on the data (e.g., based on the acquired intelligence). In an example implementation, the machine learning model is capable of modifying itself (e.g., its algorithm) to make determinations that are more accurate, precise, and/or relevant to an AI input without being explicitly programmed to do so.

An AI input indicates (e.g., specifies) a task that is to be performed by an AI model. Examples of an AI input include but are not limited to an AI prompt and an application programming interface (API) input. An AI prompt is an AI input that causes (e.g., triggers) an AI model to generate an answer that is responsive to the AI prompt. An answer to an AI prompt is referred to herein as an “AI response.” Examples of an AI prompt include but are not limited to a zero-shot prompt, a one-shot prompt, and a few-shot prompt. A zero-shot prompt is a prompt that indicates a task to be performed by an AI model that has not been trained on example(s) of the task. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

In an example, an AI input is a natural language input. A natural language input is an AI input that is written in a natural language. A natural language is a human language that has developed through use and repetition. In an example, the natural language has developed naturally without conscious planning or premeditation. Examples of a natural language include English, French, Spanish, and Mandarin. In an aspect, the natural language input is generated by a user (e.g., a human). In another aspect, the natural language input is generated by a computing system (e.g., an AI assistant that runs on the computing system).

In another example, an AI input is not written in a natural language. In an implementation of this example, the AI input includes (e.g., is) computer code. The AI input may be any suitable sequence of characters that is capable of being interpreted by an AI model.

An API input is an AI input that is provided via an API to request a service or a function. An API is an interface between a computing system and code (e.g., software or firmware).

Example embodiments described herein are capable of causing an AI model to recommend a change to a computational notebook using an alternative notebook format. Example techniques described herein have a variety of benefits as compared to conventional techniques for using an AI model to perform an operation with regard to a computational notebook. For instance, the example techniques are capable of causing an AI model to recommend a change to a computational notebook more accurately, precisely, quickly, efficiently, and/or reliably than the conventional techniques. In an aspect, the example techniques are capable of increasing a statistical accuracy and/or a statistical precision with which the AI model determines the recommended change, as compared to the conventional techniques. In an example of this aspect, the recommended change is more useful or relevant than change(s) that otherwise would have been recommended by the conventional techniques.

The example techniques are capable of reducing an amount of time and/or resources (e.g., processor cycles, memory, network bandwidth) that is consumed by a computing system to determine a recommended change to a computational notebook. In an example implementation, by receiving a deserialized notebook file, which results from deserialization of a notebook file that defines a computational notebook in a data serialization format, the computational notebook including multiple cells that include respective subroutines and outputs of the respective subroutines; serializing the deserialized notebook file to provide a serialized notebook file, the serializing comprising: removing the outputs of the respective subroutines from the deserialized notebook file; adding hash values, which uniquely identify the cells, in the deserialized notebook file; and adding representations of valid programming code snippets, which represent the respective subroutines, in the deserialized notebook file; causing an AI model to recommend a change to the notebook file by providing an AI input together with contextual information to the AI model, the AI input requesting a recommendation of the change, the contextual information including the serialized notebook file, the contextual information including context regarding the AI input; receiving an AI output from the AI model, the AI output including the recommendation of the change; and/or providing a visual representation of the recommendation of the change via a user interface, the example techniques reduce the amount of time and/or resources that is consumed to determine the recommended change to the computational notebook.

In an aspect, the example techniques automate determining a recommended change to a computational notebook. For instance, the example techniques may automate any one or more of the operations described above with regard to the example implementation. In another aspect, by reducing the amount of time and/or resources that is consumed by a computing system to determine a recommended change to a computational notebook, the efficiency of the computing system is increased. In yet another aspect, by reducing the amount of time and/or resources that is consumed by a computing system to determine the recommended change to the computational notebook, a cost associated with determining the recommended change is reduced.

In another aspect, by reducing the amount of time that is consumed to determine a recommended change to a computational notebook, the example techniques increase a user experience and/or efficiency of a developer of the computational notebook. The example techniques may reduce a number of tasks that are manually performed by the developer by utilizing artificial intelligence and/or by automating determination of the recommended change to the computational notebook.

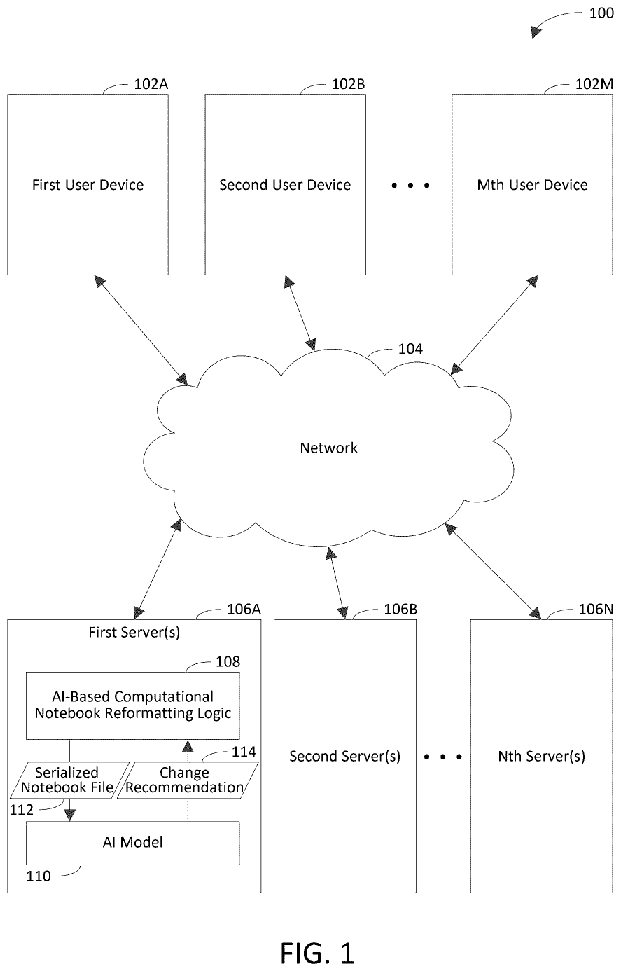

FIG. 1 is a block diagram of an example AI-based computational notebook reformatting system 100 in accordance with an embodiment. Generally speaking, the AI-based computational notebook reformatting system 100 operates to provide information to users in response to requests (e.g., hypertext transfer protocol (HTTP) requests) that are received from the users. In an aspect, the information includes documents (Web pages, images, audio files, video files, etc.), output of executables, and/or any other suitable type of information. In accordance with example embodiments described herein, the AI-based computational notebook reformatting system 100 causes an AI model 110 to recommend a change to a computational notebook using an alternative notebook format. Detail regarding techniques for causing an AI model to recommend a change to a computational notebook using an alternative notebook format is provided in the following discussion.

As shown in FIG. 1, the AI-based computational notebook reformatting system 100 includes a plurality of user devices 102A-102M, a network 104, and a plurality of servers 106A-106N. Communication among the user devices 102A-102M and the servers 106A-106N is carried out over the network 104 using well-known network communication protocols. In an aspect, the network 104 is a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors. In an example, the one or more processors are on a same (e.g., single) device. In another example, the one or more processors are distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. In an example, a user initiates a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M are able to access information that is available via the domains. In an aspect, the domains include Web page(s). In an example, the Web page(s) are provided as hypertext markup language (HTML) documents and objects (e.g., files) that are linked therein.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. In an example, the information includes documents (Web pages, images, audio files, video files, etc.), output of executables, or any other suitable type of information. In accordance with some example embodiments, the servers 106A-106N are configured to host respective Web sites, so that the Web sites are accessible to users of the AI-based computational notebook reformatting system 100.

One example type of computer program that may be executed by one or more of the servers 106A-106N or by any of the user devices 102A-102M is a developer tool. A developer tool is a computer program that performs diagnostic operations (e.g., identifying source of problem, debugging, profiling, controlling, etc.) with respect to program code. Examples of a developer tool include but are not limited to an artificial intelligence (AI) service suite, an integrated development environment (IDE), and a web development platform.

An AI service suite is a program that provides tools that are usable by software developers to build, deploy, and scale AI applications (e.g., AI models). In an aspect, the AI service suite enables the software developers to build, deploy, and/or scale AI application(s) without needing extensive AI or data science expertise. An example of an AI service suite is an Azure AI Cloud™ suite, developed distributed by Microsoft Corporation.

An integrated development environment (IDE) is a program that provides tools that are usable by software developers to develop software. In an aspect, the IDE includes a source code editor, build automation tool(s), a debugger, a compiler, and/or an interpreter. Examples of an IDE include but are not limited to a Microsoft Visual Studio® IDE, developed and distributed by Microsoft Corporation; an AppCode® IDE, a PhpStorm® IDE, a Rider® IDE, a WebStorm® IDE, etc., developed and distributed by JetBrains s.r.o.: a JDeveloper® IDE, developed and distributed by Oracle International Corporation; a NetBeans® IDE, developed and distributed by Sun Microsystems, Inc.: an Eclipse™ IDE, developed and distributed by Eclipse Foundation; and an Android Studio™ IDE, developed and distributed by Google LLC and JetBrains s.r.o.

A web development platform is a program that provides tools that are usable by software developers to create, deploy, and manage web applications. In an aspect, the tools perform functions such as web hosting, database management, and/or content delivery. Examples of a web development platform include but are not limited to a Windows Azure® platform, developed and distributed by Microsoft Corporation; an Amazon Web Services® platform, developed and distributed by Amazon.com, Inc.: a Google App Engine® platform, developed and distributed by Google LLC; a VMWare® platform, developed and distributed by VMWare, Inc.: and a Force.com® platform, developed and distributed by Salesforce, Inc.

It will be recognized that the example techniques described herein may be implemented using a developer tool.

In an aspect, a developer tool is incorporated into a cloud computing program (e.g., a cloud service). A cloud computing program is a computer program that provides hosted service(s) via a network (e.g., network 104). In an example, the hosted service(s) are hosted by any one or more of the servers 106A-106N. In another example, the cloud computing program enables users (e.g., at any of the user systems 102A-102M) to access shared resources that are stored on or are otherwise accessible to the server(s) via the network.

In an example of this aspect, the cloud computing program provides hosted service(s) according to a service model. Examples of a service model include but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). In an example, IaaS provides to the user virtualized computing resources that utilize the IaaS provider's physical computer resources.

Examples of a cloud computing program include but are not limited to a Google Cloud® program developed and distributed by Google Inc.: an Oracle Cloud® program developed and distributed by Oracle Corporation; an Amazon Web Services® program developed and distributed by Amazon.com, Inc.: a Salesforce® program developed and distributed by Salesforce.com, Inc.: an AppSource® program developed and distributed by Microsoft Corporation; an Azure® program developed and distributed by Microsoft Corporation; a GoDaddy® program developed and distributed by GoDaddy.com LLC; and a Rackspace® program developed and distributed by Rackspace US, Inc. In an aspect, one or more of the example techniques described herein are implemented using a cloud computing program. In an example, a software product (e.g., a subscription service, a non-subscription service, or a combination thereof) includes the cloud computing program, and the software product is configured to perform the example techniques.

The first server(s) 106A are shown to include AI-based computational notebook reformatting logic 108 and the AI model 110 for illustrative purposes. The AI-based computational notebook reformatting logic 108 is configured to cause the AI model 110 to recommend a change to a computational notebook using an alternative notebook format. In an example implementation, the AI-based computational notebook reformatting logic 108 receives a deserialized notebook file, which results from deserialization of a notebook file that defines a computational notebook in a data serialization format. The computational notebook includes multiple cells that include respective subroutines and outputs of the respective subroutines. The AI-based computational notebook reformatting logic 108 serializes the deserialized notebook file to provide a serialized notebook file 112. The serializing includes removing the outputs of the respective subroutines from the deserialized notebook file. The serializing further includes adding hash values, which uniquely identify the cells, in the deserialized notebook file. The serializing further includes adding representations of valid programming code snippets, which represent the respective subroutines, in the deserialized notebook file. The AI-based computational notebook reformatting logic 108 causes the AI model 110 to generate a change recommendation 114, which recommends a change to the notebook file, by providing an AI input together with contextual information to the AI model 110. The AI input requests the change recommendation 114. The contextual information including the serialized notebook file 112. The contextual information includes context regarding the AI input. The AI-based computational notebook reformatting logic 108 receives an AI output from the AI model 110. The AI output includes the change recommendation 114. The AI-based computational notebook reformatting logic 108 provides a visual representation of the change recommendation 114 via a user interface.

The AI-based computational notebook reformatting logic 108 may be implemented in various ways to cause an AI model to recommend a change to a computational notebook using an alternative notebook format, including being implemented in hardware, software, firmware, or any combination thereof. In an aspect, the AI-based computational notebook reformatting logic 108 is implemented as computer program code configured to be executed in one or more processors. In another aspect, at least a portion of the AI-based computational notebook reformatting logic 108 is implemented as hardware logic/electrical circuitry. In an example of this aspect, at least a portion of the AI-based computational notebook reformatting logic 108 is implemented in a field-programmable gate array (FPGA), an application-specific integrated circuit (ASIC), an application-specific standard product (ASSP), a system-on-a-chip system (SoC), and/or a complex programmable logic device (CPLD). In an example, each SoC includes an integrated circuit chip that includes one or more of a processor (a microcontroller, microprocessor, digital signal processor (DSP), etc.), memory, one or more communication interfaces, and/or further circuits and/or embedded firmware to perform its functions.

In an aspect, the AI-based computational notebook reformatting logic 108 is (or is included in) a developer tool and/or a cloud computing program.

The AI-based computational notebook reformatting logic 108 and the AI model 112 are shown to be incorporated in the first server(s) 106A for illustrative purposes and are not intended to be limiting. It will be recognized that the AI-based computational notebook reformatting logic 108 and/or the AI model 112 (or any portion(s) thereof) may be incorporated in any one or more of the servers 106A-106N, any one or more of the user devices 102A-102M, or any combination thereof. In an example, client-side aspects of the AI-based computational notebook reformatting logic 108 and/or the AI model 112 are incorporated in one or more of the user devices 102A-102M, and server-side aspects of the AI-based computational notebook reformatting logic 108 and/or the AI model 112 are incorporated in one or more of the servers 106A-106N.

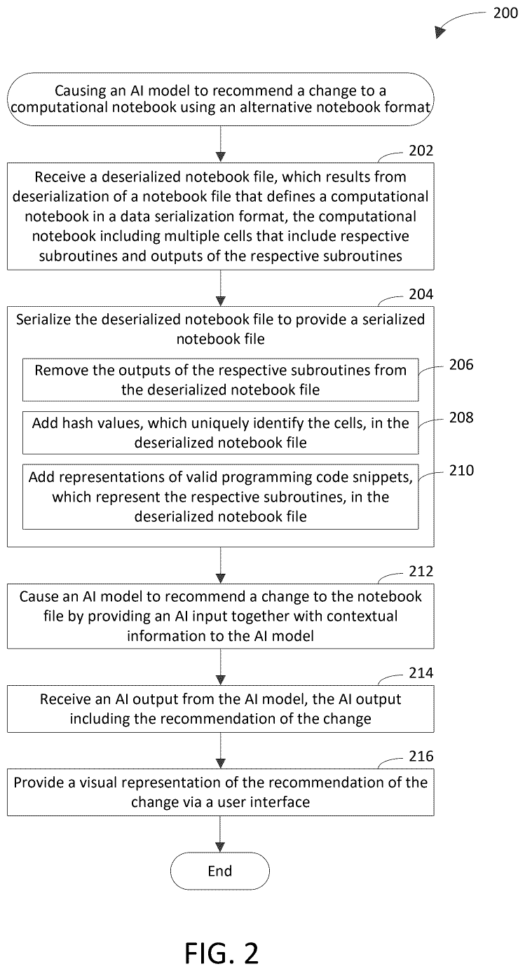

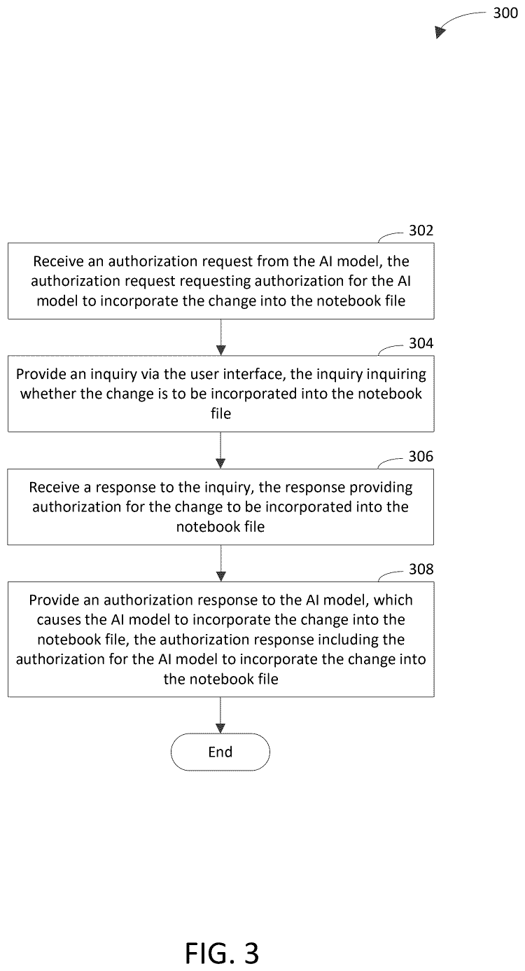

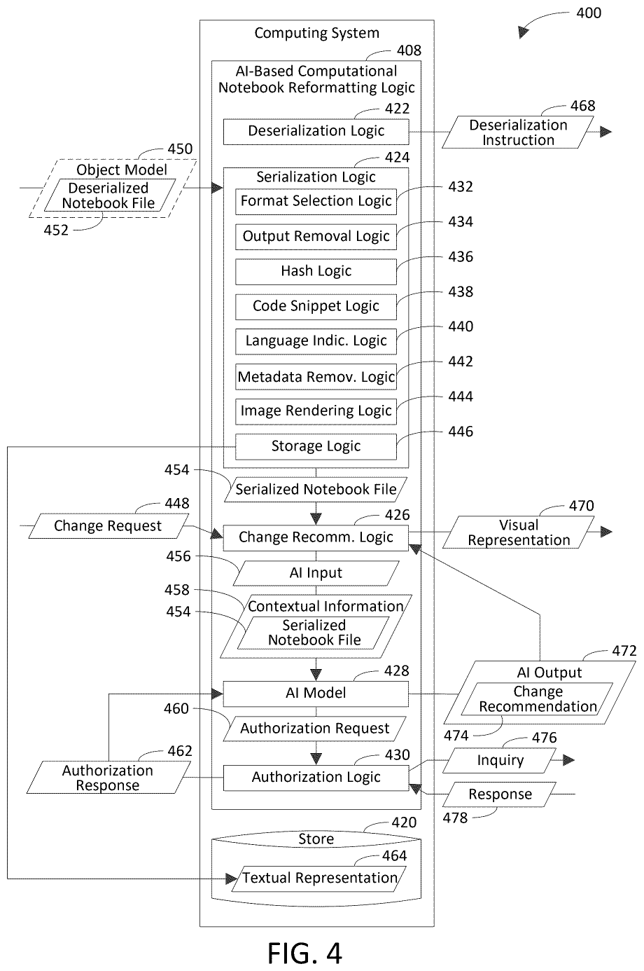

FIGS. 2-3 depict flowcharts 200 and 300 of example methods for causing an AI model to recommend a change to a computational notebook using an alternative notebook format in accordance with embodiments. Flowcharts 200 and 300 may be performed by the first server(s) 106A shown in FIG. 1, for example. For illustrative purposes, flowcharts 200 and 300 are described with respect to a computing system 400 shown in FIG. 4, which is an example implementation of the first server(s) 106A. As shown in FIG. 4, the computing system 400 includes AI-based computational notebook reformatting logic 408 and a store 420. The AI-based computational notebook reformatting logic 408 includes deserialization logic 422, serialization logic 424, change recommendation logic 426, an AI model 428, and authorization logic 430. The serialization logic 424 includes format selection logic 432, output removal logic 434, hash logic 436, code snippet logic 438, language indication logic 440, metadata removal logic 442, image rendering logic 444, and storage logic 446. The store 420 may be any suitable type of store. One type of store is a database. Examples of a database include but are not limited to a relational database, an entity-relationship database, an object database, an object relational database, and an extensible markup language (XML) database. The store 420 is shown to store a textual representation 464 of a serialized notebook file 454 for non-limiting, illustrative purposes. Further structural and operational embodiments will be apparent to persons skilled in the relevant art(s) based on the discussion regarding flowcharts 200 and 300.

As shown in FIG. 2, the method of flowchart 200 begins at step 202. In step 202, a deserialized notebook file is received. The deserialized notebook file results from deserialization of a notebook file that defines a computational notebook in a data serialization format. Deserialization is a process of converting serialized data into a data structure (e.g., an object) from which the serialized data was generated. Serialized data is data that is serialized. Serialization is a process of converting a data structure into a format that is capable of being stored or transmitted and later reconstructed. The computational notebook includes multiple cells that include respective subroutines and outputs of the respective subroutines. In an aspect, a first cell of the computational notebook includes a first subroutine and a first output of the first subroutine; a second cell of the computational notebook includes a second subroutine and a second output of the second subroutine, and so on. In another aspect, the cells in the computational notebook are associated with respective instances of a code editor. In an example of this aspect, a first cell in the computational notebook is associated with a first instance of the code editor; a second cell in the computational notebook is associated with a second instance of the code editor, and so on. Accordingly, the first instance of the code editor may be used to develop a first subroutine that is included in the first cell; the second instance of the code edit may be used to develop a second subroutine that is included in the second cell, and so on. In yet another aspect, content of the computational notebook is formatted to have the data serialization format. The content includes the cells of the computational notebook. In an example of this aspect, the content further includes metadata that is external to the cells and that pertains to the cells. For instance, the metadata may include markdown content pertaining to the cells. Markdown content is metadata that is written in a markdown language. A markdown language is a markup language that is used to format text. A markup language is a language that defines structure and presentation of raw text. The markup language is usable to annotate a document in a manner that is syntactically distinguishable from text in the document. For instance, the text in the document may define the document. In an aspect, the markup language uses tags to define elements in the document. In an example, the markdown content describes the cells of the computational notebook.

A data serialization format is a format in which data (e.g., an object) is characterized (e.g., configured) as a sequence of bits. The data serialization format may have any of a variety of attributes, including but not limited to interoperability, human-readability, compactness, schema support, ease of parsing, and support for complex data types. Interoperability enables data exchange between different programming languages, platforms, or systems. Human-readability enables the data to be read and edited by a human. Compactness reduces a size of the resulting formatted data (e.g., for efficient storage and transmission). Schema support provides support for a schema that defines the structure of the data (e.g., to enable validation and versioning). Ease of parsing enables the resulting formatted data to be easily parsed and generated by software (e.g., with libraries available in multiple programming languages). Support for complex data types enables the data to be characterized using complex data types. Examples of a complex data type include but are not limited to a nested structure, an array, and a key-value pair.

Examples of a data serialization format include but are not limited to an ASN.1™ serialization format, developed and distributed by the International Organization for Standards (ISO), the International Electrotechnical Commission (IEC), and the International Telecommunication Union Telecommunication Standardization Sector (ITU-T); an Efficient XML Interexchange™ (EXI) serialization format, developed and distributed by the World Wide Web Consortium (W3C); an Ion™ serialization format, developed and distributed by Amazon.com, Inc.: a Java® serialization format, developed and distributed by Oracle Corporation; a JSON™ serialization format, developed and distributed by Douglas Crockford; a Netstrings™ serialization format, developed and distributed by Dan Bernstein; a PHP™ serialization format, developed and distributed by the PHP Group; a Pickle™ serialization format, developed and distributed by Guido van Rossum; a Property list™ serialization format, developed by NeXT, Inc. and distributed by Apple Inc.: a Protocol Buffers® serialization format, developed and distributed by Google LLC; a SOAP™ serialization format, developed and distributed by W3C; an eXternal Data Representation™ serialization format, developed by Sun Microsystems, Inc. and distributed by the Internet Engineering Task Force (IETF); an XML™ serialization format, developed and distributed by W3C; and a YAML™ serialization format, developed and distributed by Clark Evans, Ingy döt Net, and Oren Ben-Kiki.

In an example implementation, the serialization logic 424 receives a deserialized notebook file 452, which results from deserialization of the notebook file that defines the computational notebook.

In an example embodiment, receiving the deserialized notebook file at step 202 includes causing the notebook file to be deserialized to provide the deserialized notebook file. In an aspect, causing the notebook file to be deserialized includes generating the deserialized notebook file by deserializing the notebook file. In an example implementation, the deserialization logic 422 provides a deserialization instruction 468, which causes the notebook file to be deserialized to provide the deserialized notebook file 452.

The notebook file may be written in any suitable format. In an aspect, the notebook file is written in a binary format. In another aspect, the notebook file is written in plaintext format. In yet another aspect, the notebook file is written in a JSON™ format. In still another aspect, the notebook file is written in an extensible markup language (XML) format.

At step 204, the deserialized notebook file is serialized to provide a serialized notebook file. In an aspect, the serialized notebook file is a plaintext file (i.e., a file written in plaintext). In another aspect, the serialized notebook file is a JSON™ file (i.e., a file written in a JSON™ format). In still another aspect, the serialized notebook file is an XML file (i.e., a file written in an XML format). In an example implementation, the serialization logic 424 serializes the deserialized notebook file 452 to provide the serialized notebook file 454.

In an example embodiment, serializing the deserialized notebook file at step 204 includes configuring the serialized notebook file to have a selected format, which is selected from a plurality of formats as a result of a criterion being satisfied. In an aspect, the criterion requires a first value to be greater than second value(s). The first value indicates a first extent to which a first value of an attribute of the selected format corresponds to a reference value of a reference attribute associated with AI model. The second value(s) indicate a second extent to which a second value of the attribute of each other format (e.g., besides the selected format) in the plurality of formats corresponds to the reference value of the reference attribute associated with AI model. In an aspect of this embodiment, the plurality of formats includes two or more of the following: an XML format, a plaintext format, and/or a JSON format. In another aspect of this embodiment, the plurality of formats includes an XML format, a plaintext format, and a JSON format. In yet another aspect of this embodiment, the selected format is agnostic with regard to (e.g., independent from) a format that the notebook file has prior to the notebook file being deserialized. For instance, the format that the notebook file has prior to the notebook file being deserialized may be a .NET™ notebook format, a Jupyter® notebook format, or a GitHub® issues notebook format. In still another aspect of this embodiment, the selected format is agnostic with regard to a format of the deserialized notebook file.

Step 204 includes step 206, 208, and 210. At step 206, the outputs of the respective subroutines are removed from the deserialized notebook file. In an aspect, a first output of a first subroutine, which is included in a first cell of the computational notebook, is removed from the deserialized notebook file; a second output of a second subroutine, which is included in a second cell of the computational notebook, is removed from the deserialized notebook file, and so on. In another aspect, by removing the outputs of the respective subroutines from the deserialized notebook file, a size of the serialized notebook file may be at least a designated amount (e.g., 10%, 20%, 30%, 40%, or 50%) smaller than a size of the deserialized notebook file. In an example of this aspect, an amount of time that is consumed to process the serialized notebook file is substantially less than an amount of time that would be consumed to process the deserialized notebook file. In an example implementation, the output removal logic 434 removes the outputs of the respective subroutines from the deserialized notebook file 452.

At step 208, hash values are added in the deserialized notebook file. The hash values uniquely identify the cells. In an aspect, a first hash value uniquely identifies a first cell of the computational notebook; a second hash value uniquely identifies a second cell of the computational notebook, and so on. In another aspect, the hash values are generated by encoding cell identifiers, which are associated with the respective cells, using a secure hash algorithm (SHA). Examples of a secure hash algorithm include but are not limited to SHA-224, SHA-256, SHA-384, and SHA-512. In an example of this aspect, the cell identifiers include contents of the respective cells or portions thereof. In yet another aspect, by adding the hash values in the deserialized notebook file, issues associated with using traditional indexing are avoided. Traditional indexing involves assigning consecutive numbers (i.e., 1, 2, 3, . . . , n) to successive cells in accordance with an execution order of the cells. In traditional indexing, the numbers that are assigned to the cells often correspond to a first instance at which each cell is executed. Accordingly, it may not be possible to determine a number of times that a cell is executed when traditional indexing is used. Use of traditional indexing often causes an AI model to introduce errors when cells are added or deleted from a computational notebook. For instance, the AI model may renumber the cells or perform operations with regard to wrong cells. In another aspect, by adding the hash values in the deserialized notebook file, accuracy, precision, and/or reliability of operations performed by the AI model is increased. In an example implementation, the hash logic 436 adds the hash values in the deserialized notebook file 452.

At step 210, representations of valid programming code snippets are added in the deserialized notebook file. A valid programming code snippet is a programming code snippet that conforms to syntax rules of a programming language (e.g., a particular programming language in which the programming code snippet is written). The representations of the valid programming code snippets represent the respective subroutines. In an aspect, a first representation of a first valid programming code snippet represents a first subroutine, which is included in a first cell of the computational notebook; a second representation of a second valid programming code snippet represents a second subroutine, which is included in a second cell of the computational notebook, and so on. In an example implementation, the code snippet logic 438 adds the representations of the valid programming code snippets in the deserialized notebook file 452.

In an example embodiment, adding the representations of the valid programming code snippets in the deserialized notebook file at step 210 includes adding encoded representations of the valid programming code snippets in the deserialized notebook file. In an aspect, the serialized notebook file is in a JSON format. In another aspect, the encoded representations include the valid programming code snippets escaped between character combinations in the deserialized notebook file. One example of a character combination is a combination of a backslash and a quote (i.e., \”).

In another example embodiment, adding the representations of the valid programming code snippets in the deserialized notebook file at step 210 includes adding the valid programming code snippets in the deserialized notebook file. In an aspect, the serialized notebook file is in an XML format or a plaintext format. In another aspect, adding the valid programming code snippets in the deserialized notebook file includes adding executable programming code snippets, which represent the respective subroutines, in the deserialized notebook file. An executable programming code snippet is a programming code snippet that is capable of being executed by a computing system without encountering an error during execution. In yet another aspect, adding the valid programming code snippets in the deserialized notebook file includes adding valid Python® code snippets, which represent the respective subroutines, in the deserialized notebook file. A Python® code snippet is a code snippet that is written in a Python® programming language, which is developed and distributed by Python Software Foundation.

It will be recognized that step 204 may include step(s) in addition to or in lieu of steps 206, 208, and/or 210. For instance, in an example embodiment, serializing the deserialized notebook file at step 204 further includes adding language indicators in the deserialized notebook file. Each language indicator indicates a programming language in which the respective subroutine is written in a corresponding cell that is included in the cells. In an example implementation, the language indicator logic 440 adds the language indicators in the deserialized notebook file 452.

In another example embodiment, the notebook file includes metadata associated with the cells. In an aspect, the metadata includes markdown content. In an example of this aspect, the markdown content includes descriptions of the cells. In accordance with this embodiment, serializing the deserialized notebook file at step 204 further includes removing the metadata associated with the cells from the deserialized notebook file. In an example implementation, the metadata removal logic 442 removes the metadata associated with the cells from the deserialized notebook file 452.

In yet another example embodiment, the deserialized notebook file includes a textual representation of an image file. In accordance with this embodiment, serializing the deserialized notebook file at step 204 further includes rendering the textual representation of the image file in the deserialized notebook file to provide a rendered representation of the image. In an example implementation, the deserialized notebook file 452 includes the textual representation of the image file. In accordance with this implementation, the image rendering logic 444 renders the textual representation of the image file in the deserialized notebook file 452 to provide the rendered representation of the image. In an aspect, the image rendering logic 444 determines (e.g., confirms) that the AI model 428 supports rendered images. In accordance with this aspect, the image rendering logic 444 renders the textual representation of the image file in the deserialized notebook file 452 as a result of determining that the AI model 428 supports rendered images.

At step 212, an AI model is caused to recommend a change to the notebook file by providing an AI input together with contextual information to the AI model. The AI input requests a recommendation (e.g., a suggestion) of the change. The contextual information includes the serialized notebook file. The contextual information includes context regarding the AI input. In an example, the context includes intent of an entity from which the AI input is received. In another example, the context includes intent of an entity from which a request, which results in the AI input, is received. In accordance with this example, the AI input may be derived from the request. In an example implementation, the change recommendation logic 426 causes the AI model 428 to recommend the change to the notebook file by providing an AI input 456 together with contextual information 458 to the AI model 428. The AI input 456 requests a change recommendation 474, which includes the recommendation of the change. The contextual information 458 includes the serialized notebook file 454., The contextual information 458 includes context regarding the AI input 456.

In an example cell order embodiment, the recommendation of the change includes a recommendation to change an order of the cells in the notebook file to correspond to an execution order in which the respective subroutines in the cells are executed. In an aspect, the execution order is determined from content of the cells in the notebook file. In an example of this aspect, the cells include numbers indicating a sequence in which the cells are executed. For instance, one of the cells includes a sequence number of “1”; another one of the cells includes a sequence number of “2”, and so on. In another aspect, the execution order is determined from executing the computational notebook (e.g., the notebook file) and observing a sequence in which the cells are executed. In an example implementation, the deserialization logic 422 and/or the serialization logic 424 determines the execution order in which the respective subroutines in the cells are executed. In an aspect, the contextual information 458 includes an indication of the execution order. In an example of this aspect, the serialized notebook file 454, which is included in the contextual information 458, includes the indication of the execution order.

In an example variable name embodiment, causing the AI model to recommend the change to the notebook file at step 212 includes causing the AI model to determine that an instance of a variable name in a first cell of the notebook file is changed to an updated variable name and to recommend changing another instance of the variable name in a second cell of the notebook file to the updated variable name by providing the AI input together with the contextual information to the AI model. In an aspect of this embodiment, the serialized notebook file is written in a plaintext format.

In an example next cell embodiment, the contextual information that is provided together with the AI input to the AI model indicates an order of execution of the cells in the notebook file. In accordance with this embodiment, causing the AI model to recommend the change to the notebook file at step 212 includes causing the AI model to recommend content of a next cell to be added to the cells in the notebook file by taking into consideration the order of execution of the cells in the notebook file. In an example implementation, the contextual information 458 indicates the order of execution of the cells in the notebook file. In accordance with this implementation, the change recommendation logic 426 causes the AI model 428 recommend the content of the next cell to be added to the cells in the notebook file by taking into consideration the order of execution of the cells in the notebook file, as indicated by the contextual information 458. In an aspect, the change recommendation logic 426 generates (e.g., automatically generates) a prompt that requests creation of the next cell. In an example of this aspect, the change recommendation logic 426 includes the prompt in the AI input 456 that is provided to the AI model 428.

In an example error identification embodiment, causing the AI model to recommend the change to the notebook file at step 212 includes causing the AI model to identify an error in an identified representation of a valid programming code snippet and to recommend the change to the notebook file, which is configured to correct the error, by providing the AI input together with the contextual information to the AI model. In accordance with this embodiment, the identified representation of the valid programming code snippet is included in the representations of the valid programming code snippets. In an example implementation, the change recommendation logic 426 causes the AI model 428 to identify the error in the identified representation of the valid programming code snippet and to recommend the change to the notebook file, which is configured to correct the error, by providing the AI input 456 together with the contextual information 458 to the AI model 428.

In an example change incorporation embodiment, causing the AI model to recommend the change to the notebook file at step 212 includes causing the AI model to automatically incorporate the change into the notebook file by providing the AI input together with the contextual information to the AI model. In accordance with this embodiment, the AI input requests incorporation of the change into the notebook file. In an example implementation, the change recommendation logic 426 causes the AI model 428 to automatically incorporate the change into the notebook file. In accordance with this implementation, the AI input 456 requests incorporation of the change into the notebook file.

At step 214, an AI output is received from the AI model. The AI output includes the recommendation of the change. In an example implementation, the change recommendation logic 426 receives an AI output 472 from the AI model 428. The AI output 472 includes the change recommendation 474.

At step 216, providing a visual representation of the recommendation of the change via a user interface. In an aspect, the visual representation of the recommendation is implemented as a textual suggestion. In another aspect, the visual representation of the recommendation is implemented as a code difference (e.g., showing addition(s), deletion(s), and/or change(s) to the notebook file). In an example implementation, the change recommendation logic 426 provides a visual representation 470 of the change recommendation 474 via the user interface.

In an aspect of the next-cell embodiment mentioned above, the AI output, which is received at step 214, includes an indication (e.g., a representation) of the next cell to be added to the cells in the notebook file. For instance, the AI output may include content of the next cell or a link to the content of the next cell. In an example of this aspect, the visual representation of the recommendation of the change, which is provided at step 216, includes a visual representation of the next cell, which includes the recommended content. For instance, the visual representation of the next cell may be provided via the user interface for user approval.

In some example embodiments, one or more steps 202, 204, 206, 208, 210, 212, 214, and/or 216 of flowchart 200 may not be performed. Moreover, steps in addition to or in lieu of steps 202, 204, 206, 208, 210, 212, 214, and/or 216 may be performed. For instance, in an example authorization embodiment, receiving the deserialized notebook file at step 202 includes receiving an object model that includes the deserialized notebook file. In accordance with this embodiment, the method of flowchart 200 further includes storing a textual representation of the serialized notebook file. In further accordance with this embodiment, the contextual information, which is provided together with the AI input to the AI model, includes the textual representation of the serialized notebook file. In an example implementation, the serialization logic 424 receives an object model 450 that includes the deserialized notebook file 452. In accordance with this implementation, the storage logic 446 stores the textual representation 464 of the serialized notebook file 454 in the store 420. In further accordance with this implementation, the contextual information 458, which the change recommendation logic 426 provides together with the AI input 456 to the AI model 428, includes the textual representation 464 of the serialized notebook file 454.

In another example embodiment, the method of flowchart 200 further includes receiving a change request via the user interface. The change request requests the change to the notebook file. In an example implementation, the change recommendation logic 426 receives a change request 448, which requests the change to the notebook file. In accordance with this embodiment, causing the AI model to recommend the change to the notebook file at step 212 includes causing the AI model to recommend a modified version of the notebook file, which is configured to incorporate the change, by providing the AI input together with the contextual information to the AI model. In an example implementation, the change recommendation logic 426 causes the AI model 428 to recommend the modified version of the notebook file by providing the AI input 456 together with the contextual information 458 to the AI model 428 (e.g., in response to receipt of the change request 448). In further accordance with this embodiment, receiving the AI output at step 214 includes receiving the AI output, which includes the modified version of the notebook file, from the AI model. In an example implementation, the change recommendation logic 426 receives the AI output 472, which includes the modified version of the notebook file, from the AI model 428. In an aspect, the change recommendation 474 includes the modified version of the notebook file. In further accordance with this embodiment, providing the visual representation of the recommendation of the change at step 216 includes, in response to receiving the change request and the AI output, providing a visual representation of the modified version of the notebook file via the user interface. In an example implementation, in response to the change recommendation logic 426 receiving the change request 448 and the AI output 472, the change recommendation logic 426 provides the visual representation 470 the visual representation of the modified version of the notebook file via the user interface. In an aspect, the visual representation 470 includes the visual representation of the modified version of the notebook file.

In yet another example embodiment, the method of flowchart 200 further includes one or more of the steps shown in flowchart 300 of FIG. 3. As shown in FIG. 3, the method of flowchart 300 begins at step 302. In step 302, an authorization request is received from the AI model. The authorization request requests authorization for the AI model to incorporate the change into the notebook file. In an aspect, the authorization request is received at step 302 in response to the AI input being provided together with the contextual information to the AI model. In another aspect, step 302 is included in step 214 of flowchart 200. In an example implementation, the authorization logic 430 receives an authorization request 460 from the AI model 428. The authorization request 460 requests authorization for the AI model 428 to incorporate the change into the notebook file.

At step 304, an inquiry is provided via the user interface. The inquiry inquires whether the change is to be incorporated into the notebook file. In an aspect, the inquiry is provided at step 304 in response to the authorization request. In an example implementation, the authorization logic 430 provides an inquiry 476 via the user interface. The inquiry 476 inquires whether the change is to be incorporated into the notebook file. In an aspect, the authorization logic 430 provides the inquiry 476 in response to receipt of the authorization request 460.

At step 306, a response to the inquiry is received. The response provides authorization for the change to be incorporated into the notebook file. In an example implementation, the authorization logic 430 receives a response 478 to the inquiry 476. The response 478 provides the authorization for the change to be incorporated into the notebook file.

At step 308, an authorization response is provided to the AI model, which causes the AI model to incorporate the change into the notebook file. The authorization response includes the authorization for the AI model to incorporate the change into the notebook file. In an aspect, the authorization response is provided to the AI model in response to receiving the response to the inquiry. In an example implementation, the authorization logic 430 provides an authorization response 462 to the AI model 428, which causes the AI model 428 to incorporate the change into the notebook file. The authorization response 462 includes the authorization for the AI model 428 to incorporate the change into the notebook file. In an aspect, the authorization logic 430 provides the authorization response 462 to the AI model 428 in response to receiving the response 478 to the inquiry 476.

In an example embodiment, the change recommendation logic 426 causes (e.g., triggers) the AI model 428 to analyze (e.g., develop and/or refine an understanding of) the AI input 456, the contextual information 458 (including the serialized notebook file 454), relationships between any of the foregoing, and confidences in those relationships. In an aspect, the change recommendation logic 426 causes the AI model 428 to compare features of the AI input 456 and the contextual information 458 (including the serialized notebook file 454) using artificial intelligence to determine a recommended change to be made to the notebook file. In an example, the contextual information 458 further includes sample AI input(s) and sample contextual information (e.g., sample serialized notebook file(s)).

In some example embodiments, the AI model 428 includes a neural network that uses the artificial intelligence to determine (e.g., predict) relationships between any of the AI inputs described herein and any of the corresponding contextual information and confidences in the relationships. The neural network uses those relationships to generate the corresponding AI outputs. In an example, attributes of the AI input, the contextual information, and potentially example AI input(s) and example AI output(s) that are responsive to the AI input(s) are compared to determine similarities and differences between those attributes. In accordance with this example, the neural network uses those similarities and differences to generate the corresponding AI responses.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the change recommendation logic 426 employs a feed forward neural network to train the AI model 428, which is used to determine AI-based confidences. In an example, such AI-based confidences are used to determine likelihoods that events will occur.

A transformer-based neural network is a neural network that incorporates a transformer. A transformer is a deep learning model that utilizes attention to differentially weight the significance of each portion of sequential input data, such as natural language. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. In an example, the transformer is trained to identify the context of each portion using any suitable technique, such as gradient descent.

In an example embodiment, the transformer-based neural network generates a change recommendation model (e.g., to recommend changes to notebook files) by utilizing information, such as AI inputs, contextual information, relationships between any of the foregoing, and AI-based confidences that are derived therefrom.

In example embodiments, the change recommendation logic 426 includes training logic, and the AI model 428 includes inference logic. The training logic is configured to train AI algorithm(s) of the AI model 428 that the inference logic uses to determine (e.g., infer) the AI-based confidences. In an example, the training logic provides sample AI inputs and sample contextual information as inputs to the AI algorithm(s) to train the AI algorithm(s). In another example, the sample data is labeled. In yet another example, the AI algorithm(s) are configured to derive relationships between the features (e.g., the AI input 456 and the contextual information 458) and the resulting AI-based confidences. The inference logic is configured to utilize the AI algorithm(s), which are trained by the training logic, to determine the AI-based confidence when the features are provided as inputs to the algorithm.

In an example embodiment, the AI model 428 is a generative language model. A generative language model is an AI model that is capable of generating original text output based on sample data. Examples of a generative language model include but are not limited to a generative pre-trained transformer 3 (GPT-3®) model and a generative pre-trained transformer 4 (GPT-4®) model, developed and distributed by OpenAI, Inc.: a Phi™ model and a Turing-NLG™ model, developed and distributed by Microsoft Corporation; a large language model Meta AI (LLaMA®) model, developed and distributed by Meta Platforms Inc.: a language model for dialogue applications (LaMDA®) model and a Gemini® model, developed and distributed by Google LLC; and a BigScience large open-science open-access multilingual language model (BLOOM) model, developed and distributed by the BigScience collaborative initiative. A generative language model may use any suitable relevancy determination and/or ranking technique. In an example, the generative language model uses a BM25 (Okapi BM25) ranking function to perform its analysis (e.g., based on keywords).

In another example embodiment, the AI model 428 is a large language model (LLM). A large language model is an artificial neural network that is capable of performing natural language processing (NLP) tasks. In an example, the large language model uses a transformer model to perform the NLP tasks. In an aspect, the large language model is trained (e.g., pre-trained) using self-supervised learning and semi-supervised learning. Examples of a large language model include but are not limited to the GPT-3® and GPT-4® models, developed and distributed by OpenAI, Inc.: the LLaMA® model, developed and distributed by Meta Platforms Inc.: and a pathways language model (PaLM®) model and the Gemini® model, developed and distributed by Google LLC.

In yet another example embodiment, the AI model 428 is an embedding model. An embedding model is an AI model that uses deep learning to convert data into vectors, which represent attributes of the data, and that compares at least a subset of the vectors to determine an extent to which the vectors that are included in the subset are similar. In an aspect, each vector represents a semantic meaning of one or more AI inputs, one or more instances of contextual information, and/or one or more AI outputs. In another aspect, an embedding is a numerical representation of data (e.g., one or more data items, such as the AI input 456, the contextual information 458, or the serialized notebook file 454 (or a portion thereof). In an example of this aspect, the embedding is generated by converting the data (e.g., text) into a vector (e.g., an array of numbers). In another example of this aspect, the embedding represents the meaning and the context of the data. In another example of this aspect, embeddings serve as generic representations of a corpus of data without requiring explicit feature engineering. In an aspect of this embodiment, the AI model 428 generates AI output(s) (e.g., AI output 472) to AI input(s) (e.g., AI input 456) described herein using an embedding model. In an example of this aspect, the embedding model is an encoder-only model. One example of an encoder-only model is the bidirectional encoder representations from transformers (BERT™) model, which is developed and distributed by Google LLC. In another example of this aspect, the embedding model is a decoder-only model. In yet another example of this aspect, the embedding model is an encoder-decoder model. One example of an encoder-decoder model is the FLAN-T5™ model, which is developed and distributed by Google LLC. An embedding that represents multiple data items may be a combination (e.g., average or median) of respective embeddings of the data items.

In still another example embodiment, the AI model 428 includes multiple types of AI models. In an example, weights are applied to the responses generated by the respective types of AI models. In an aspect, the multiple types of AI models include a generative AI model and an embedding model. In an example of this aspect, a first weight is applied to a first response generated by the generative AI model to provide a first weighted response, and a second weight that is different from the first weight is applied to a second response of the embedding model to provide a second weighted response. In accordance with this example, the AI model 428 combines (e.g., sums) the first weighted response and the second weighted response to generate a combined response of the AI model 428.

In an example implementation, the computing system 400 does not include one or more of the AI-based computational notebook reformatting logic 408, the store 420, the deserialization logic 422, the serialization logic 424, the change recommendation logic 426, the AI model 428, the authorization logic 430, the format selection logic 432, the output removal logic 434, the hash logic 436, the code snippet logic 438, the language indication logic 440, the metadata removal logic 442, the image rendering logic 444, and/or the storage logic 446. In another example implementation, the computing system 400 includes component(s) in addition to or in lieu of the AI-based computational notebook reformatting logic 408, the store 420, the deserialization logic 422, the serialization logic 424, the change recommendation logic 426, the AI model 428, the authorization logic 430, the format selection logic 432, the output removal logic 434, the hash logic 436, the code snippet logic 438, the language indication logic 440, the metadata removal logic 442, the image rendering logic 444, and/or the storage logic 446.

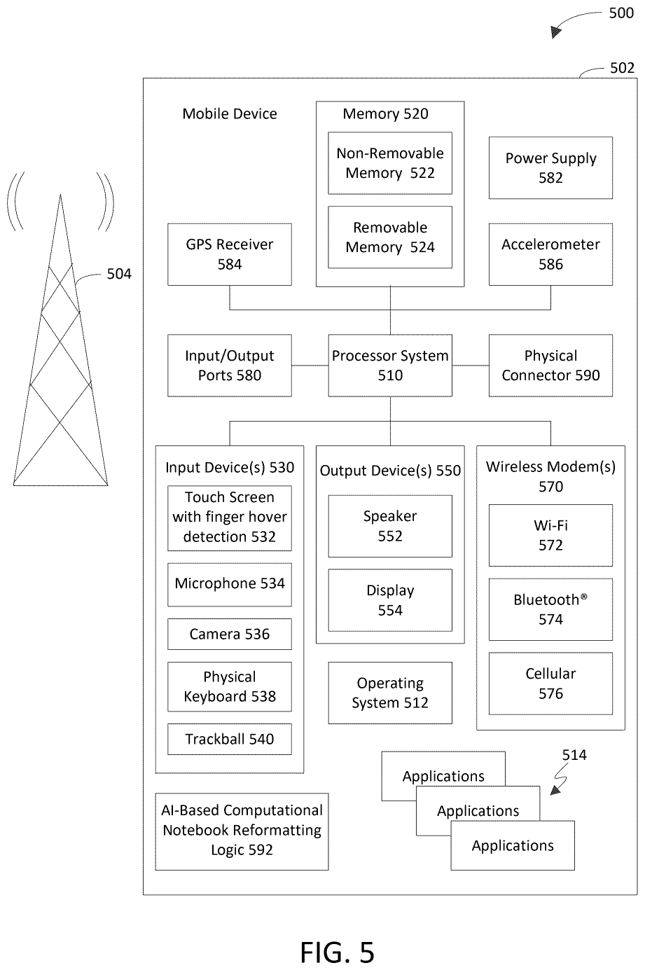

FIG. 5 is a system diagram of an example mobile device 500 including a variety of optional hardware and software components, shown generally as 502. Any components 502 in the mobile device may communicate with any other component, though not all connections are shown, for ease of illustration. The mobile device 500 may be any of a variety of computing devices (e.g., cell phone, smartphone, handheld computer, Personal Digital Assistant (PDA), etc.) and may allow wireless two-way communications with one or more mobile communications networks 504, such as a cellular or satellite network, or with a local area or wide area network.

The mobile device 500 includes a processor system 510 (e.g., signal processor, microprocessor, ASIC, or other control and processing logic circuitry) for performing such tasks as signal coding, data processing, input/output processing, power control, and/or other functions. An operating system 512 may control the allocation and usage of the components 502 and support for one or more applications 514. The applications 514 may include common mobile computing applications (e.g., email applications, calendars, contact managers, web browsers, messaging applications) and any other computing applications (e.g., word processing applications, mapping applications, media player applications).

The mobile device 500 includes AI-based computational notebook reformatting logic 592, which is operable in a manner similar to the AI-based computational notebook reformatting logic 108 described above with reference to FIG. 1 and/or the AI-based computational notebook reformatting logic 408 described above with reference to FIG. 4.

The mobile device 500 includes memory 520. The memory 520 may include non-removable memory 522 and/or removable memory 524. The non-removable memory 522 may include random access memory (RAM), read-only memory (ROM), flash memory, a hard disk, or other well-known memory storage technologies. The removable memory 524 may include flash memory or a Subscriber Identity Module (SIM) card, which is well known in Global System for Mobile Communications (GSM) systems, or other well-known memory storage technologies, such as “smart cards.” The memory 520 may store data and/or code for running the operating system 512 and the applications 514. Example data may include web pages, text, images, sound files, video data, or other data sets to be sent to and/or received from one or more network servers or other devices via one or more wired or wireless networks. Memory 520 may store a subscriber identifier, such as an International Mobile Subscriber Identity (IMSI), and an equipment identifier, such as an International Mobile Equipment Identifier (IMEI). Such identifiers may be transmitted to a network server to identify users and equipment.

The mobile device 500 may support one or more input devices 530, such as a touch screen 532, microphone 534, camera 536, physical keyboard 538 and/or trackball 540 and one or more output devices 550, such as a speaker 552 and a display 554. Touch screens, such as the touch screen 532, may detect input in different ways. For example, capacitive touch screens detect touch input when an object (e.g., a fingertip) distorts or interrupts an electrical current running across the surface. As another example, touch screens may use optical sensors to detect touch input when beams from the optical sensors are interrupted. Physical contact with the surface of the screen is not necessary for input to be detected by some touch screens. For example, the touch screen 532 may support a finger hover detection using capacitive sensing, as is well understood. Other detection techniques may be used, including camera-based detection and ultrasonic-based detection. To implement a finger hover, a user's finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

Other possible output devices (not shown) may include piezoelectric or other haptic output devices. Some devices may serve more than one input/output function. For example, touch screen 532 and display 554 may be combined in a single input/output device. The input devices 530 may include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 512 or applications 514 may include speech-recognition software as part of a voice control interface that allows a user to operate the mobile device 500 via voice commands. Furthermore, the mobile device 500 may include input devices and software that allows for user interaction via a user's spatial gestures, such as detecting and interpreting gestures to provide input to a gaming application.

Wireless modem(s) 570 may be coupled to antenna(s) (not shown) and may support two-way communications between the processor system 510 and external devices, as is well understood in the art. The modem(s) 570 are shown generically and may include a cellular modem 576 for communicating with the mobile communication network 504 and/or other radio-based modems (e.g., Bluetooth® 574 and/or Wi-Fi 572). At least one of the wireless modem(s) 570 is typically configured for communication with one or more cellular networks, such as a GSM network for data and voice communications within a single cellular network, between cellular networks, or between the mobile device and a public switched telephone network (PSTN).

The mobile device 500 may further include at least one input/output port 580, a power supply 582, a satellite navigation system receiver 584, such as a Global Positioning System (GPS) receiver, an accelerometer 586, and/or a physical connector 590, which may be a universal serial bus (USB) port, IEEE 1394 (FireWire) port, and/or RS-232 port. The illustrated components 502 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. In an example, operations described sequentially are in some cases rearranged or performed concurrently. Moreover, for the sake of simplicity, the attached figures may not show the various ways in which the disclosed methods may be used in conjunction with other methods.

Any one or more of the AI-based computational notebook reformatting logic 108, the AI model 110, the AI-based computational notebook reformatting logic 408, the deserialization logic 422, the serialization logic 424, the change recommendation logic 426, the AI model 428, the authorization logic 430, the format selection logic 432, the output removal logic 434, the hash logic 436, the code snippet logic 438, the language indication logic 440, the metadata removal logic 442, the image rendering logic 444, the storage logic 446, flowchart 200, and/or flowchart 300 may be implemented in hardware, software, firmware, or any combination thereof.

For example, any one or more of the AI-based computational notebook reformatting logic 108, the AI model 110, the AI-based computational notebook reformatting logic 408, the deserialization logic 422, the serialization logic 424, the change recommendation logic 426, the AI model 428, the authorization logic 430, the format selection logic 432, the output removal logic 434, the hash logic 436, the code snippet logic 438, the language indication logic 440, the metadata removal logic 442, the image rendering logic 444, the storage logic 446, flowchart 200, and/or flowchart 300 may be implemented, at least in part, as computer program code configured to be executed in one or more processors.

In another example, any one or more of the AI-based computational notebook reformatting logic 108, the AI model 110, the AI-based computational notebook reformatting logic 408, the deserialization logic 422, the serialization logic 424, the change recommendation logic 426, the AI model 428, the authorization logic 430, the format selection logic 432, the output removal logic 434, the hash logic 436, the code snippet logic 438, the language indication logic 440, the metadata removal logic 442, the image rendering logic 444, the storage logic 446, flowchart 200, and/or flowchart 300 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. In an example, a SoC includes an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

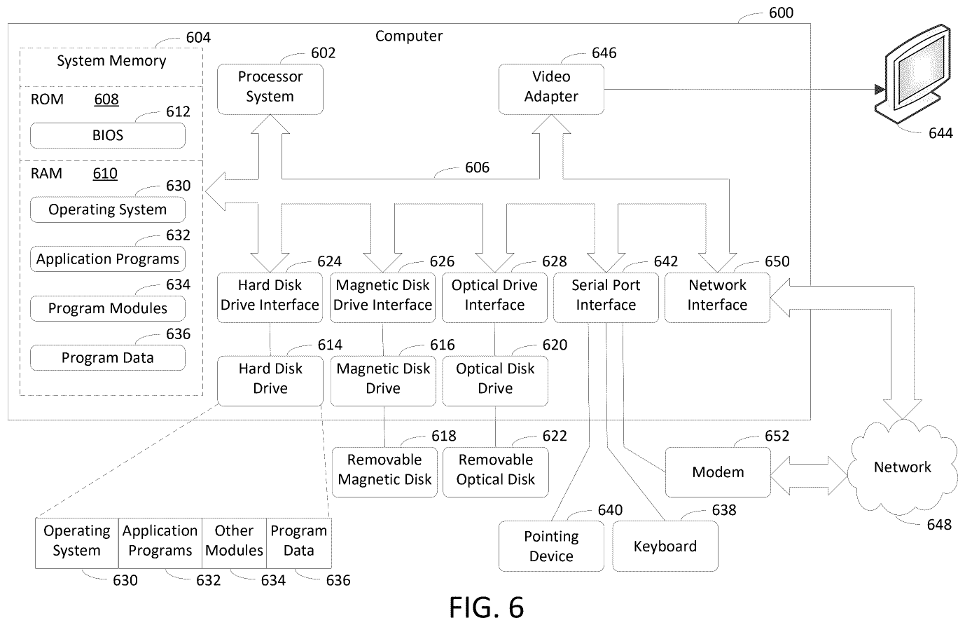

(A1) An example system (FIG. 1, 102A-102M, 106A-106N; FIG. 4, 400; FIG. 5, 502; FIG. 6, 600) comprises a processor system (FIG. 5, 510; FIG. 6, 602) and a memory (FIG. 5, 520, 522, 524; FIG. 6, 604, 608, 610) that stores computer-executable instructions. The computer-executable instructions are executable by the processor system to at least receive (FIG. 2, 202) a deserialized notebook file (FIG. 4, 452), which results from deserialization of a notebook file that defines a computational notebook in a data serialization format. The computational notebook includes multiple cells that include respective subroutines and outputs of the respective subroutines. The computer-executable instructions are executable by the processor system further to at least serialize (FIG. 2, 204) the deserialized notebook file to provide a serialized notebook file (FIG. 4, 454) by performing the following: remove (FIG. 2, 206) the outputs of the respective subroutines from the deserialized notebook file; add (FIG. 2, 208) hash values, which uniquely identify the cells, in the deserialized notebook file; and add (FIG. 2, 210) representations of valid programming code snippets, which represent the respective subroutines, in the deserialized notebook file. The computer-executable instructions are executable by the processor system further to at least cause (FIG. 2, 212) an AI model (FIG. 4, 428) to recommend a change to the notebook file by providing an AI input (FIG. 4, 456) together with contextual information (FIG. 4, 458) to the AI model. The AI input requests a recommendation (FIG. 4, 474) of the change. The contextual information includes the serialized notebook file. The contextual information includes context regarding the AI input. The computer-executable instructions are executable by the processor system further to at least receive (FIG. 2, 214) an AI output (FIG. 4, 472) from the AI model. The AI output includes the recommendation of the change. The computer-executable instructions are executable by the processor system further to at least provide (FIG. 2, 216) a visual representation (FIG. 4, 470) of the recommendation of the change via a user interface.
(A2) In the example system of A1, wherein the computer-executable instructions are executable by the processor system to at least: cause the notebook file to be deserialized to provide the deserialized notebook file.
(A3) In the example system of any of A1-A2, wherein the notebook file is written in JSON format.
(A4) In the example system of any of A1-A3, wherein the serialized notebook file is a plaintext notebook file.
(A5) In the example system of any of A1-A4, wherein the computer-executable instructions are executable by the processor system to serialize the deserialized notebook file by performing the following: configure the serialized notebook file to have a selected format, which is selected from a plurality of formats as a result of a first extent to which a first value of an attribute of the selected format corresponds to a reference value of a reference attribute associated with AI model being greater than a second extent to which a second value of the attribute of each other format in the plurality of formats corresponds to the reference value of the reference attribute associated with AI model.
(A6) In the example system of any of A1-A5, wherein the computer-executable instructions are executable by the processor system to at least: add encoded representations of the valid programming code snippets in the deserialized notebook file.
(A7) In the example system of any of A1-A6, wherein the computer-executable instructions are executable by the processor system to at least: add the valid programming code snippets in the deserialized notebook file.
(A8) In the example system of any of A1-A7, wherein the computer-executable instructions are executable by the processor system to at least: add executable programming code snippets, which represent the respective subroutines, in the deserialized notebook file.
(A9) In the example system of any of A1-A8, wherein the computer-executable instructions are executable by the processor system to at least: add valid Python code snippets, which represent the respective subroutines, in the deserialized notebook file.
(A10) In the example system of any of A1-A9, wherein the computer-executable instructions are executable by the processor system to at least: receive an object model that includes the deserialized notebook file; and store a textual representation of the serialized notebook file; and wherein the contextual information, which is provided together with the AI input to the AI model, includes the textual representation of the serialized notebook file.
(A11) In the example system of any of A1-A10, wherein the computer-executable instructions are executable by the processor system to serialize the deserialized notebook file further by performing the following: add language indicators in the deserialized notebook file, each language indicator indicating a programming language in which the respective subroutine is written in a corresponding cell that is included in the cells.
(A12) In the example system of any of A1-A11, wherein the notebook file includes metadata associated with the cells; and wherein the computer-executable instructions are executable by the processor system to serialize the deserialized notebook file further by performing the following: remove the metadata associated with the cells from the deserialized notebook file.
(A13) In the example system of any of A1-A12, wherein the deserialized notebook file includes a textual representation of an image file; and wherein the computer-executable instructions are executable by the processor system to serialize the deserialized notebook file further by performing the following: render the textual representation of the image file in the deserialized notebook file to provide a rendered representation of the image.
(A14) In the example system of any of A1-A13, wherein the recommendation of the change comprises: the recommendation to change an order of the cells in the notebook file to correspond to an execution order in which the respective subroutines in the cells are executed.
(A15) In the example system of any of A1-A14, wherein the contextual information that is provided together with the AI input to the AI model indicates an order of execution of the cells in the notebook file; and wherein the computer-executable instructions are executable by the processor system to at least: cause the AI model to recommend content of a next cell to be added to the cells in the notebook file by taking into consideration the order of execution of the cells in the notebook file.
(A16) In the example system of any of A1-A15, wherein the computer-executable instructions are executable by the processor system to at least: receive a change request via the user interface, the change request requesting the change to the notebook file; cause the AI model to recommend a modified version of the notebook file, which is configured to incorporate the change, by providing the AI input together with the contextual information to the AI model; receive the AI output, which includes the modified version of the notebook file, from the AI model; and in response to receipt of the change request and the AI output, provide a visual representation of the modified version of the notebook file via the user interface.
(A17) In the example system of any of A1-A16, wherein the computer-executable instructions are executable by the processor system to recommend the change to the notebook file by performing the following: cause the AI model to determine that an instance of a variable name in a first cell of the notebook file is changed to an updated variable name and to recommend changing another instance of the variable name in a second cell of the notebook file to the updated variable name by providing the AI input together with the contextual information to the AI model.
(A18) In the example system of any of A1-A17, wherein the computer-executable instructions are executable by the processor system to at least: in response to the AI input being provided together with the contextual information to the AI model, receive an authorization request from the AI model, the authorization request requesting authorization for the AI model to incorporate the change into the notebook file; in response to the authorization request, provide an inquiry via the user interface, the inquiry inquiring whether the change is to be incorporated into the notebook file; receive a response to the inquiry, the response providing authorization for the change to be incorporated into the notebook file; and in response to receipt of the response to the inquiry, provide an authorization response to the AI model, which causes the AI model to incorporate the change into the notebook file, the authorization response including the authorization for the AI model to incorporate the change into the notebook file.
(A19) In the example system of any of A1-A18, wherein the computer-executable instructions are executable by the processor system to at least: cause the AI model to automatically incorporate the change into the notebook file by providing the AI input together with the contextual information to the AI model, wherein the AI input requests incorporation of the change into the notebook file.
(A20) In the example system of any of A1-A19, wherein the computer-executable instructions are executable by the processor system to at least: cause the AI model to identify an error in an identified representation of a valid programming code snippet, which is included in the representations of the valid programming code snippets, and to recommend the change to the notebook file, which is configured to correct the error, by providing the AI input together with the contextual information to the AI model.
(B1) A example method is implemented by a computing system (FIG. 1, 102A-102M, 106A-106N; FIG. 4, 400; FIG. 5, 502; FIG. 6, 600). The method comprises receiving (FIG. 2, 202) a deserialized notebook file (FIG. 4, 452), which results from deserialization of a notebook file that defines a computational notebook in a data serialization format. The computational notebook includes multiple cells that include respective subroutines and outputs of the respective subroutines. The method further comprises serializing (FIG. 2, 204) the deserialized notebook file to provide a serialized notebook file (FIG. 4, 454). The serializing comprises: removing (FIG. 2, 206) the outputs of the respective subroutines from the deserialized notebook file; adding (FIG. 2, 208) hash values, which uniquely identify the cells, in the deserialized notebook file; and adding (FIG. 2, 210) valid programming code snippets, which represent the respective subroutines, in the deserialized notebook file. The method further comprises causing (FIG. 2, 212) an AI model (FIG. 4, 428) to recommend a change to the notebook file by providing an AI input (FIG. 4, 456) together with contextual information (FIG. 4, 458) to the AI model. The AI input requests a recommendation of the change. The contextual information includes the serialized notebook file. The contextual information includes context regarding the AI input. The method further comprises receiving (FIG. 2, 214) an AI output (FIG. 4, 472) from the AI model. The AI output includes the recommendation of the change. The method further comprises providing (FIG. 2, 216) a visual representation (FIG. 4, 470) of the recommendation of the change via a user interface.
(B2) In the example method of B1, wherein receiving the deserialized notebook file comprises: causing the notebook file to be deserialized to provide the deserialized notebook file.
(B3) In the example method of any of B1-B2, wherein the notebook file is written in JSON format.
(B4) In the example method of any of B1-B3, wherein the serialized notebook file is a plaintext notebook file.
(B5) In the example method of any of B1-B4, wherein serializing the deserialized notebook file comprises: configuring the serialized notebook file to have a selected format, which is selected from a plurality of formats as a result of a first extent to which a first value of an attribute of the selected format corresponds to a reference value of a reference attribute associated with AI model being greater than a second extent to which a second value of the attribute of each other format in the plurality of formats corresponds to the reference value of the reference attribute associated with AI model.
(B6) In the example method of any of B1-B5, wherein adding the valid programming code snippets in the deserialized notebook file comprises: adding executable programming code snippets, which represent the respective subroutines, in the deserialized notebook file.
(B7) In the example method of any of B1-B6, wherein adding the valid programming code snippets in the deserialized notebook file comprises: adding valid Python code snippets, which represent the respective subroutines, in the deserialized notebook file.
(B8) In the example method of any of B1-B7, wherein receiving the deserialized notebook file comprises: receiving an object model that includes the deserialized notebook file; wherein the method further comprises: storing a textual representation of the serialized notebook file; and wherein the contextual information, which is provided together with the AI input to the AI model, includes the textual representation of the serialized notebook file.
(B9) In the example method of any of B1-B8, wherein serializing the deserialized notebook file further comprises: adding language indicators in the deserialized notebook file, each language indicator indicating a programming language in which the respective subroutine is written in a corresponding cell that is included in the cells.
(B10) In the example method of any of B1-B9, wherein the notebook file includes metadata associated with the cells; and wherein serializing the deserialized notebook file further comprises: removing metadata associated with the cells from the deserialized notebook file.
(B11) In the example method of any of B1-B10, wherein the deserialized notebook file includes a textual representation of an image file; and wherein serializing the deserialized notebook file further comprises: rendering the textual representation of the image file in the deserialized notebook file to provide a rendered representation of the image.
(B12) In the example method of any of B1-B11, wherein the recommendation of the change comprises: the recommendation to change an order of the cells in the notebook file to correspond to an execution order in which the respective subroutines in the cells are executed.
(B13) In the example method of any of B1-B12, wherein the contextual information that is provided together with the AI input to the AI model indicates an order of execution of the cells in the notebook file; and wherein causing the AI model to recommend the change to the notebook file comprises: causing the AI model to recommend content of a next cell to be added to the cells in the notebook file by taking into consideration the order of execution of the cells in the notebook file.
(B14) In the example method of any of B1-B13, further comprising: receiving a change request via the user interface, the change request requesting the change to the notebook file; wherein causing the AI model to recommend the change to the notebook file comprises: causing the AI model to recommend a modified version of the notebook file, which is configured to incorporate the change, by providing the AI input together with the contextual information to the AI model; wherein receiving the AI output comprises: receiving the AI output, which includes the modified version of the notebook file, from the AI model; and wherein providing the visual representation of the recommendation of the change comprises: in response to receiving the change request and the AI output, providing a visual representation of the modified version of the notebook file via the user interface.
(B15) In the example method of any of B1-B14, wherein causing the AI model to recommend the change to the notebook file comprises: causing the AI model to determine that an instance of a variable name in a first cell of the notebook file is changed to an updated variable name and to recommend changing another instance of the variable name in a second cell of the notebook file to the updated variable name by providing the AI input together with the contextual information to the AI model.
(B16) In the example method of any of B1-B15, wherein receiving the AI output comprises: in response to providing the AI input together with the contextual information to the AI model, receiving an authorization request from the AI model, the authorization request requesting authorization for the AI model to incorporate the change into the notebook file; and wherein the method further comprises: in response to the authorization request, providing an inquiry via the user interface, the inquiry inquiring whether the change is to be incorporated into the notebook file; receiving a response to the inquiry, the response providing authorization for the change to be incorporated into the notebook file; and in response to receiving the response to the inquiry, providing an authorization response to the AI model, which causes the AI model to incorporate the change into the notebook file, the authorization response including the authorization for the AI model to incorporate the change into the notebook file.
(B17) In the example method of any of B1-B16, wherein causing the AI model to recommend the change to the notebook file comprises: causing the AI model to automatically incorporate the change into the notebook file by providing the AI input together with the contextual information to the AI model, wherein the AI input requests incorporation of the change into the notebook file.
(C1) An example computer program product (FIG. 5, 524; FIG. 6, 618, 622) comprises a computer-readable storage medium having instructions recorded thereon for enabling a processor-based system (FIG. 1, 102A-102M, 106A-106N; FIG. 4, 400; FIG. 5, 502; FIG. 6, 600) to perform operations. The operations comprise receiving (FIG. 2, 202) a deserialized notebook file (FIG. 4, 452), which results from deserialization of a notebook file that defines a computational notebook in a data serialization format. The computational notebook includes multiple cells that include respective subroutines and outputs of the respective subroutines. The operations further comprise serializing (FIG. 2, 204) the deserialized notebook file to provide a serialized notebook file (FIG. 4, 454). The serializing comprises: removing (FIG. 2, 206) the outputs of the respective subroutines from the deserialized notebook file; adding (FIG. 2, 208) hash values, which uniquely identify the cells, in the deserialized notebook file; adding language indicators in the deserialized notebook file, each language indicator indicating a programming language in which the respective subroutine is written in a corresponding cell that is included in the cells; and adding (FIG. 2, 210) representations of valid programming code snippets, which represent the respective subroutines, in the deserialized notebook file. The operations further comprise causing (FIG. 2, 212) an AI model (FIG. 4, 428) to recommend a change to the notebook file by providing an AI input (FIG. 4, 456) together with contextual information (FIG. 4, 458) to the AI model. The AI input requests a recommendation of the change. The contextual information includes the serialized notebook file. The contextual information includes context regarding the AI input. The operations further comprise receiving (FIG. 2, 214) an AI output (FIG. 4, 472) from the AI model. The AI output includes the recommendation of the change. The operations further comprise providing (FIG. 2, 216) a visual representation (FIG. 4, 470) of the recommendation of the change via a user interface.

### III. Example Computer System

FIG. 6 depicts an example computer 600 in which embodiments may be implemented.

Any one or more of the user devices 102A-102M and/or any one or more of the servers 106A-106N shown in FIG. 1 and/or the computing system 400 shown in FIG. 4 may be implemented using computer 600, including one or more features of computer 600 and/or alternative features. In an example, computer 600 is a general-purpose computing device in the form of a conventional personal computer, a mobile computer, or a workstation, for example. In another example, computer 600 is a special purpose computing device. The description of computer 600 provided herein is provided for purposes of illustration and is not intended to be limiting. Embodiments may be implemented in further types of computer systems, as would be known to persons skilled in the relevant art(s).

As shown in FIG. 6, computer 600 includes a processor system 602, a system memory 604, and a bus 606 that couples various system components including system memory 604 to processor system 602. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random-access memory (RAM) 610. A basic input/output system 612 (BIOS) is stored in ROM 608.

Computer 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 630, one or more application programs 632, other program modules 634, and program data 636. In an example, application programs 632 and/or program modules 634 include computer program logic for implementing any one or more of (e.g., at least a portion of) the AI-based computational notebook reformatting logic 108, the AI model 110, the AI-based computational notebook reformatting logic 408, the deserialization logic 422, the serialization logic 424, the change recommendation logic 426, the AI model 428, the authorization logic 430, the format selection logic 432, the output removal logic 434, the hash logic 436, the code snippet logic 438, the language indication logic 440, the metadata removal logic 442, the image rendering logic 444, the storage logic 446, flowchart 200 (including any step of flowchart 200), and/or flowchart 300 (including any step of flowchart 300), as described herein.

A user may enter commands and information into the computer 600 through input devices, such as keyboard 638 and pointing device 640. Other examples of an input device (not shown) include but are not limited to a microphone, a joystick, a game pad, a satellite dish, a scanner, a touch screen, a camera, an accelerometer, and a gyroscope. These and other input devices often are connected to the processor system 602 through a serial port interface 642 that is coupled to bus 606, but may be connected by other interfaces, such as a parallel port, game port, or a universal serial bus (USB).

A display device 644 (e.g., a monitor) is also connected to bus 606 via an interface, such as a video adapter 646. In an example, computer 600 includes other peripheral output devices (not shown), such as speakers and printers.

Computer 600 is connected to a network 648 (e.g., the Internet) through a network interface 650 (e.g., a network adapter), a modem 652, or other means for establishing communications over the network. Modem 652 is connected to bus 606 via serial port interface 642. In an example, modem 652 is incorporated into the computer. In another example, modem 652 is external to computer 600.

As used herein, the terms “computer program medium” and “computer-readable storage medium” are used to generally refer to media (e.g., non-transitory media) such as the hard disk associated with hard disk drive 614, removable magnetic disk 618, removable optical disk 622, as well as other media such as flash memory cards, digital video disks, random access memories (RAMs), read only memories (ROM), and the like. A computer-readable storage medium is not a signal, such as a carrier signal or a propagating signal. In an example, a computer-readable storage medium does not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 632 and other program modules 634) may be stored on the hard disk, magnetic disk, optical disk, ROM, or RAM. Such computer programs also may be received via network interface 650 or serial port interface 642. Such computer programs, when executed or loaded by an application, enable computer 600 to implement features of embodiments discussed herein. Accordingly, such computer programs represent controllers of the computer 600.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, though each embodiment need not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
receive a deserialized notebook file, which results from deserialization of a notebook file that defines a computational notebook in a data serialization format, the computational notebook including multiple cells that include respective subroutines and outputs of the respective subroutines;
serialize the deserialized notebook file to provide a serialized notebook file by performing the following:
remove the outputs of the respective subroutines from the deserialized notebook file;
add hash values, which uniquely identify the cells, in the deserialized notebook file; and
add representations of valid programming code snippets, which represent the respective subroutines, in the deserialized notebook file;
cause an AI model to recommend a change to the notebook file by providing an AI input together with contextual information to the AI model, the AI input requesting a recommendation of the change, the contextual information including the serialized notebook file, the contextual information including context regarding the AI input;
receive an AI output from the AI model, the AI output including the recommendation of the change; and
provide a visual representation of the recommendation of the change via a user interface.

2. The system of claim 1, wherein the computer-executable instructions are executable by the processor system to serialize the deserialized notebook file by performing the following:
configure the serialized notebook file to have a selected format, which is selected from a plurality of formats as a result of a first extent to which a first value of an attribute of the selected format corresponds to a reference value of a reference attribute associated with AI model being greater than a second extent to which a second value of the attribute of each other format in the plurality of formats corresponds to the reference value of the reference attribute associated with AI model.

3. The system of claim 1, wherein the computer-executable instructions are executable by the processor system to at least:
cause the AI model to identify an error in an identified representation of a valid programming code snippet, which is included in the representations of the valid programming code snippets, and to recommend the change to the notebook file, which is configured to correct the error, by providing the AI input together with the contextual information to the AI model.

4. The system of claim 1, wherein the computer-executable instructions are executable by the processor system to at least:
add encoded representations of the valid programming code snippets in the deserialized notebook file.

5. The system of claim 1, wherein the computer-executable instructions are executable by the processor system to at least:
add the valid programming code snippets in the deserialized notebook file.

6. The system of claim 1, wherein the computer-executable instructions are executable by the processor system to serialize the deserialized notebook file further by performing the following:
add language indicators in the deserialized notebook file, each language indicator indicating a programming language in which the respective subroutine is written in a corresponding cell that is included in the cells.

7. The system of claim 1, wherein the notebook file includes metadata associated with the cells; and
wherein the computer-executable instructions are executable by the processor system to serialize the deserialized notebook file further by performing the following:
remove the metadata associated with the cells from the deserialized notebook file.

8. The system of claim 1, wherein the deserialized notebook file includes a textual representation of an image file; and
wherein the computer-executable instructions are executable by the processor system to serialize the deserialized notebook file further by performing the following:
render the textual representation of the image file in the deserialized notebook file to provide a rendered representation of the image.

9. The system of claim 1, wherein the recommendation of the change comprises:
the recommendation to change an order of the cells in the notebook file to correspond to an execution order in which the respective subroutines in the cells are executed.

10. The system of claim 1, wherein the contextual information that is provided together with the AI input to the AI model indicates an order of execution of the cells in the notebook file; and
wherein the computer-executable instructions are executable by the processor system to at least:
cause the AI model to recommend content of a next cell to be added to the cells in the notebook file by taking into consideration the order of execution of the cells in the notebook file.

11. The system of claim 1, wherein the computer-executable instructions are executable by the processor system to recommend the change to the notebook file by performing the following:
cause the AI model to determine that an instance of a variable name in a first cell of the notebook file is changed to an updated variable name and to recommend changing another instance of the variable name in a second cell of the notebook file to the updated variable name by providing the AI input together with the contextual information to the AI model.

12. The system of claim 1, wherein the computer-executable instructions are executable by the processor system to at least:
in response to the AI input being provided together with the contextual information to the AI model, receive an authorization request from the AI model, the authorization request requesting authorization for the AI model to incorporate the change into the notebook file;
in response to the authorization request, provide an inquiry via the user interface, the inquiry inquiring whether the change is to be incorporated into the notebook file;
receive a response to the inquiry, the response providing authorization for the change to be incorporated into the notebook file; and
in response to receipt of the response to the inquiry, provide an authorization response to the AI model, which causes the AI model to incorporate the change into the notebook file, the authorization response including the authorization for the AI model to incorporate the change into the notebook file.

13. The system of claim 1, wherein the computer-executable instructions are executable by the processor system to at least:
cause the AI model to automatically incorporate the change into the notebook file by providing the AI input together with the contextual information to the AI model, wherein the AI input requests incorporation of the change into the notebook file.

14. A method implemented by a computing system, the method comprising:
receiving a deserialized notebook file, which results from deserialization of a notebook file that defines a computational notebook in a data serialization format, the computational notebook including multiple cells that include respective subroutines and outputs of the respective subroutines;
serializing the deserialized notebook file to provide a serialized notebook file, the serializing comprising:
removing the outputs of the respective subroutines from the deserialized notebook file;
adding hash values, which uniquely identify the cells, in the deserialized notebook file; and
adding valid programming code snippets, which represent the respective subroutines, in the deserialized notebook file;
causing an AI model to recommend a change to the notebook file by providing an AI input together with contextual information to the AI model, the AI input requesting a recommendation of the change, the contextual information including the serialized notebook file, the contextual information including context regarding the AI input;
receiving an AI output from the AI model, the AI output including the recommendation of the change; and
providing a visual representation of the recommendation of the change via a user interface.

15. The method of claim 14, wherein receiving the deserialized notebook file comprises:
causing the notebook file to be deserialized to provide the deserialized notebook file.

16. The method of claim 14, wherein the notebook file is written in JSON format.

17. The method of claim 14, wherein adding the valid programming code snippets in the deserialized notebook file comprises:
adding executable programming code snippets, which represent the respective subroutines, in the deserialized notebook file.

18. The method of claim 14, wherein receiving the deserialized notebook file comprises:
receiving an object model that includes the deserialized notebook file;
wherein the method further comprises:
storing a textual representation of the serialized notebook file; and
wherein the contextual information, which is provided together with the AI input to the AI model, includes the textual representation of the serialized notebook file.

19. The method of claim 14, further comprising:
receiving a change request via the user interface, the change request requesting the change to the notebook file;
wherein causing the AI model to recommend the change to the notebook file comprises:
causing the AI model to recommend a modified version of the notebook file, which is configured to incorporate the change, by providing the AI input together with the contextual information to the AI model;
wherein receiving the AI output comprises:
receiving the AI output, which includes the modified version of the notebook file, from the AI model; and
wherein providing the visual representation of the recommendation of the change comprises:
in response to receiving the change request and the AI output, providing a visual representation of the modified version of the notebook file via the user interface.

20. A computer program product comprising a computer-readable storage medium having instructions recorded thereon for enabling a processor-based system to perform operations, the operations comprising:
receiving a deserialized notebook file, which results from deserialization of a notebook file that defines a computational notebook in a data serialization format, the computational notebook including multiple cells that include respective subroutines and outputs of the respective subroutines;
serializing the deserialized notebook file to provide a serialized notebook file, the serializing comprising:
removing the outputs of the respective subroutines from the deserialized notebook file;
adding hash values, which uniquely identify the cells, in the deserialized notebook file;
adding language indicators in the deserialized notebook file, each language indicator indicating a programming language in which the respective subroutine is written in a corresponding cell that is included in the cells; and
adding representations of valid programming code snippets, which represent the respective subroutines, in the deserialized notebook file;
causing an AI model to recommend a change to the notebook file by providing an AI input together with contextual information to the AI model, the AI input requesting a recommendation of the change, the contextual information including the serialized notebook file, the contextual information including context regarding the AI input;
receiving an AI output from the AI model, the AI output including the recommendation of the change; and
providing a visual representation of the recommendation of the change via a user interface.
